(19) United States
(12) Patent Application Publication
(10) Pub. No.: US 2007/0045977 A1
(43) Pub. Date: Mar. 1, 2007

(54) Winged skateboard

(76) Inventors: Dino S. Rocco, Staten Island, NY (US); Matthew S. Giangrande, Pleasant Garden, NC (US)

Correspondence Address: Salvatore C. Mitri, 263 Bryant Avenue, Staten Island, NY, 10306, US

(21) Appl. No.: 11/208,660

(22) Filed: Aug. 23, 2005

(51) Int. Cl. B62M 1/00

(52) U.S. Cl. 280/87.042

(57) ABSTRACT

There is disclosed a winged skateboard having a skateboard platform upon which a skateboarder stands to ride the skateboard. The skateboard platform has a designated nominal front end and a nominal rear end with a projecting member extending forward from the nominal front end a rearward projecting member extending rear ward from the nominal rear end. The forward projecting member and the rearward projecting member are the “wings” for the skateboard platform. A front pair of wheels and a rear pair of wheels are each attached to and vertically suspended from the skateboard platform.

### FIELD OF THE INVENTION

This invention is directed toward a winged skateboard. More particularly, this invention is directed toward a winged skateboard having a forward projection member and a rearward projection member. Even more particularly, this invention is directed toward a winged skateboard wherein the geometric configuration of the forward projection member and the rearward projection member each have characteristics that impart to the winged skateboard an aerodynamic effect.

### BACKGROUND OF THE INVENTION

Skateboarding is the latest craze to sweep across America and it seems to have taken a firm grip. Recreational skateboarders vary in age beginning from about four or five years old through early and late teenage years and into adults of many ages. Even some courageous senior citizens have been seen trying their hands at the sport The varying age span of recreational skateboarders means that the weight of the recreational skateboarder will also vary beginning from about 40 lbs. to about 50 lbs. up through about 120 lbs. to about 150 lbs. and as high as 180 lbs. or more. Because of this, commercially available skateboards are manufacture to be durable, sturdy, rigid and strong enough to bear these different weights.

Recreational skateboarders propel themselves forward by placing one foot on the skateboard platform while pushing themselves forward with the other foot. When the skateboarder is satisfied that sufficient forward speed has been attained, the skateboarder places the other foot on the skateboard platform and balances themselves there as the skateboard moves forward.

Recreational skateboarders generally ride their skateboards over relatively smooth, paved surfaces such as driveways, streets, sidewalks, paved pathways provided for walkers, joggers, bicyclers, roller and in-line blade skaters, and the like. Occasionally, the paved surface over which the recreational skateboarder rides is bumpy or uneven or cracked causing the front wheels of the skateboard to “dig in” or slow down. When the recreational skateboarder encounters these conditions, the more experienced skateboarder will compensate for them by shifting their weight backwards on the skateboard platform in an effort to lighten the front end of the skateboard so that the front wheels ride more readily over such surfaces. When these surfaces are encountered by the novice or less experienced skateboarder, however, they often lose their balance and are “thrown” form the skateboard onto the ground often getting bruises, contusions and scrapes. To protect these novice and less experienced skateboarders, a whole, new industry has been spawned. This industry provides the novice and less experienced skateboarder, as well as the more prudent and more experienced skateboarder, with protective equipment such as plastic “crash” helmets, elbow pads, knee pads, gloves, and the like.

Skateboarding has also given rise to a relatively new sport: competitive skateboarding. Competitive skateboarders ride their skateboards over smooth surfaces and often eschew donning protective equipment. Competitive skateboarding is discussed and described in more detail hereinabove.

Due to the manner in which they are constructed and designed, the rate of acceleration and the forward speeds attainable by both the recreational and competitive skateboarder are limited. On an equal weight basis, the top forward speeds that a recreational skateboarder can attain is about 5 mph. to about 8 mph. while the top forward speeds attainable by the competitive skateboarder is from about 12 mph. to about 15 or 16 mph. In addition, these commercially available skateboards are also limited in the height to which they can be “lifted”. “Lifting of a skateboard for a competitive skateboarder becomes very important as it will determine the amount of time that the competitive skateboarder remains airborne to perform his or her acrobatic maneuvers as also described more fully hereinbelow.

### SUMMARY OF THE INVENTION

It has now been found that the shortcomings of acceleration, forward speed and “lift” of current, commercially available skateboards used both recreationally and competitively can be significantly improved and enhanced by the winged skateboard of the invention. In general, the winged skateboard of the invention comprises: a skateboard platform having a nominal front end and a nominal rear end; an elongated forward projecting member an elongated rearward projecting member; and, two pair of spaced apart wheels, a front pair and a rear pair, said pairs of wheels being attached to and vertically suspended from said skateboard platform, each pair of said wheels being interconnected by means of a common axle.

In one embodiment, the skateboard platform has an elongated, generally rectangular configuration with a top horizontal planar surface, a bottom horizontal planar surface that is co-extensive with and parallel to said top surface; and, opposed side edges.

In another embodiment, the forward projecting member and the rearward projecting member are each contiguous to and integrally formed with said skateboard platform.

In a further embodiment, said forward projecting member has a front angular section upwardly and outwardly disposed from the nominal front end of said skateboard platform; and, a horizontal, planar front section outwardly disposed from the upper end of said front angular section.

In still another embodiment, said rearward projecting member has a rear angular section upwardly and outwardly disposed from the nominal rear end of said skateboard platform; and, a horizontal, planar rear section outwardly disposed from the upper end of said rear angular section.

In yet another embodiment, said front pair of wheels and said rear pair of wheels are each set inboard from said nominal front end and said nominal rear end, respectively.

In yet a further embodiment, said skateboard platform has a plurality of spaced apart apertures formed therein.

The foregoing embodiments of the winged skateboard of the invention as well as others described in more detail hereinbelow inherently impart to it novel characteristics and features that are not found in any of the commercial skateboards currently available.

For example, these novel characteristics and features enable a skateboarder, whether a recreational skateboarder or a competitive skateboarder, to accelerate more quickly and attain faster forward speeds than are achievable with current skateboards. Furthermore, due to its lighter and wing-like construction, the winged skateboard of the invention enables a competitive skateboarder to leap or jump higher than with current skateboards. This provides a significant advantage to the competitive skateboarder as it as it affords him or her a few precious, extra fractions of a second while he or she is air-borne in which to complete complex, acrobatic maneuvers with more ease, style and grace.

### BRIEF DESCRIPTION OF THE DRAWING

The winged skateboard of the invention is further illustrated by the attached drawing wherein:

FIG. 1 is a top plan view of a typical, commercially available skateboard;

FIG. 2 is a side elevation view of the skateboard shown in FIG. 1;

FIG. 3 is a perspective rendering of a typical competitive skateboard “arena”;

FIG. 4 is a top plan view of the winged skateboard of the invention

FIG. 5 is a side elevation view of the skateboard shown in FIG. 4; and,

FIG. 6 is an exaggerated cross-section of a skateboard aperture taken substantially on the line 4-4 of FIG. 4.

### DETAILED DESCRIPTION OF THE DRAWING AND THE INVENTION

The winged skateboard of the invention will be better understood and become more apparent from the ensuing description when considered together with the accompanying drawing wherein like reference numerals denote like parts.

A typical, commercially available skateboard of the type generally in use today is illustrated in FIGS. 1 and 2. The typical skateboard generally identified by reference numeral 10, has an elongated, generally rectangular skateboard platform 11 upon which a skateboarder stands to ride the skateboard. Platform 11 has a top horizontal planar surface 12, a bottom horizontal planar surface 13 co-extensive with and parallel to the top surface 12, opposed side edges 14 and 15, a rear end 16 and a nominal front end 16a. By “nominal” is meant, and should be understood as meaning throughout this application and in the appended claims, as that end of the platform, front or rear, where the platform 11 would normally end without any additions to it.

Extending forward from the nominal front end 16a is an elongated member 17 having opposed sides 17a and 17b that terminate in a rounded front edge 18 having an upwardly curved lip 19 best shown in FIG. 2.

Many skateboard manufacturers offer to provide a brake device with their skateboard such as that represented in FIG. 1 by dashed line 20. These brake devices are normally positioned adjacent the rear end 16 of the platform 11 and are engaged and activated by the skateboarder exerting rearward foot pressure against the device. In this way, the forward motion of the skateboard can be slowed or the skateboard brought to a complete stop.

Two pairs of spaced apart wheels, a front pair 21 and a rear pair 22, are attached to and vertically suspended from the bottom horizontal surface 13 as illustrated in FIG. 2. These wheels are the medium upon which the skateboard rests to contact a surface and enable the skateboard to be propelled over that surface. Each pair of wheels is conventionally interconnected by a common axis (not shown). The front pair of wheels 21 are set inboard from the nominal front end 16a of the platform 11 and the rear pair of wheels 22 are set inboard from the rear end 16 of the platform 11. Each pair of wheels 21 and 22 are positioned such that the outer, planar surface of each wheel does not extend beyond the vertical plane of the side edges 14 and 15.

The skateboard platform 11 of skateboards generally in use today have length of about 24″ from the rear end 16 to the nominal front end 16a; a width of about 8″ from side edge 14 to side edge 15; and, a thickness between top surface 12 and bottom surface 13 of about ½″ to about ¾″. The elongated front end is usually from about 8″ to about 10″ in length as measured from the nominal front end 16a to the rounded front edge 18 of the extension 17.

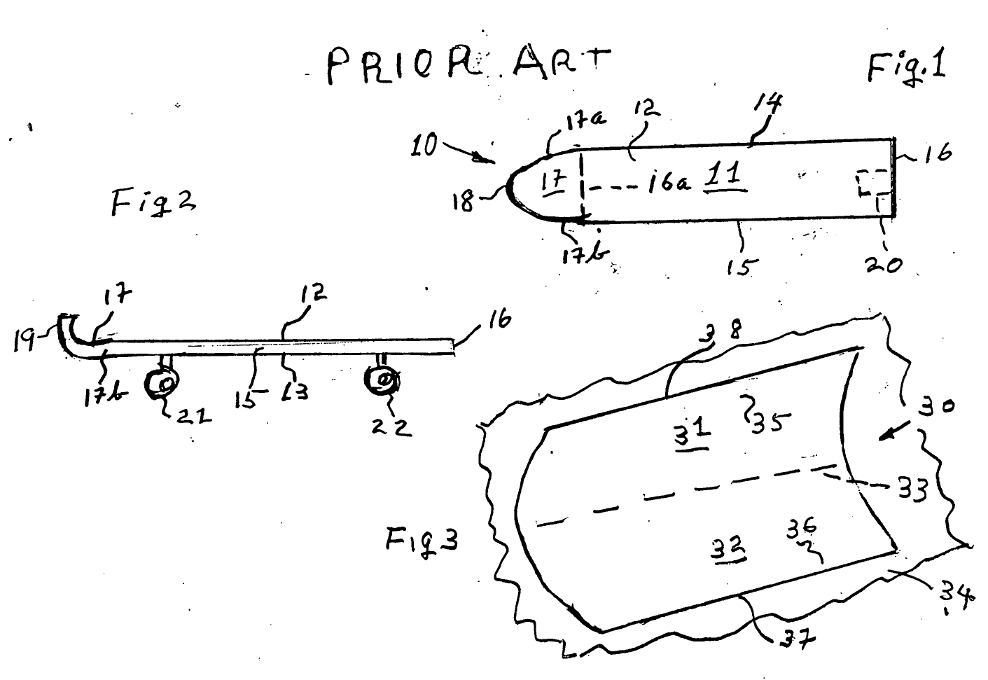

FIG. 3 illustrates a perspective rendition of a structure, generally identified by reference numeral 30, typically used as an “arena” in which skateboard competitions are held. This structure 30 has a pair of opposed, outwardly curved, convex shaped walls 31 and 32 joined at their bottom at a mid-point 33. The walls 31 and 32 are generally constructed to have smooth. Virtually seamless inner surfaces. Pre-stressed and pre-formed plywood in single or multiple plies are generally used to manufacture the structure 30. This structure is typically placed on level ground or a level, paved surface 34 and is supported in place by a plurality of external brace members (not shown). In many structures 30, a portion of the upper part of each wall 31 and 32 is vertically disposed, such as at 35 and 36 these vertical sections 35 and 36 extending downward from the parallel top edges 37 and 38 a distance of about 24″. Overall, the competitive skateboard structure resembles a tube or a tunnel with a portion of its top sheared off.

In competitive skateboarding, a competing skateboarder will begin his or her run near the top edge of one wall; say near the top edge 37 of wall 32. The skateboarder will then accelerate down the inner surface 36 gaining as much speed as possible before crossing over the joined mid-point 33 and beginning his or her ascent up the inner surface 35 of the opposite wall 31.

Just before the skateboarder reaches the upper edge 38 of that wall 31, the skateboarder executes a U-turn reversing his or her direction. U-turns are typically executed by the skateboarder leaping or jumping up into the air with the skateboard in contact with the bottoms of the skateboarder's feet and then turning their bodies while in mid-air to reverse their direction.

In advanced skateboard competition, these U-turns are often combined with front or back body flips which are sometimes further combined with mid-air body twists and turns. Such acrobatic maneuvers are similar to those performed by Olympic, uneven bar athletes during their dismounts or athletes who propel themselves upward from a pommel or horse or those athletes engaged in gymnastic floor exercises.

Scoring of competitive skateboarders is similar to that used by Olympic panels judging such events as single and pairs ice-skating, diving, uneven bars, pommel or horse, floor gymnastics, and the like. Each judge awards a competitor a score of between “1” and “10”, a “1” being the lowest score and a “10” being the highest. The aggregate of these scores then determines a winner, second place and third place among the competitors.

From the foregoing, it will be readily appreciated that competitive skateboarding requires a great deal of athletic ability including strength, balance, agility and grace. It will also be apparent that the faster the forward motion that a skateboarder can attain and the greater the acceleration to reach such speeds, the higher a skateboarder will be able to jump or leap to gain those fractions of a second needed to successfully complete and perform complex acrobatic maneuvers with grace.

Turning now to the winged skateboard of the invention, it will be obvious to those skilled in the art that some elements of the winged skateboard of the invention are similar to those found in commercially available skateboards; namely, the skateboard platform upon which a skateboarder stands to ride the skateboard and the wheels.

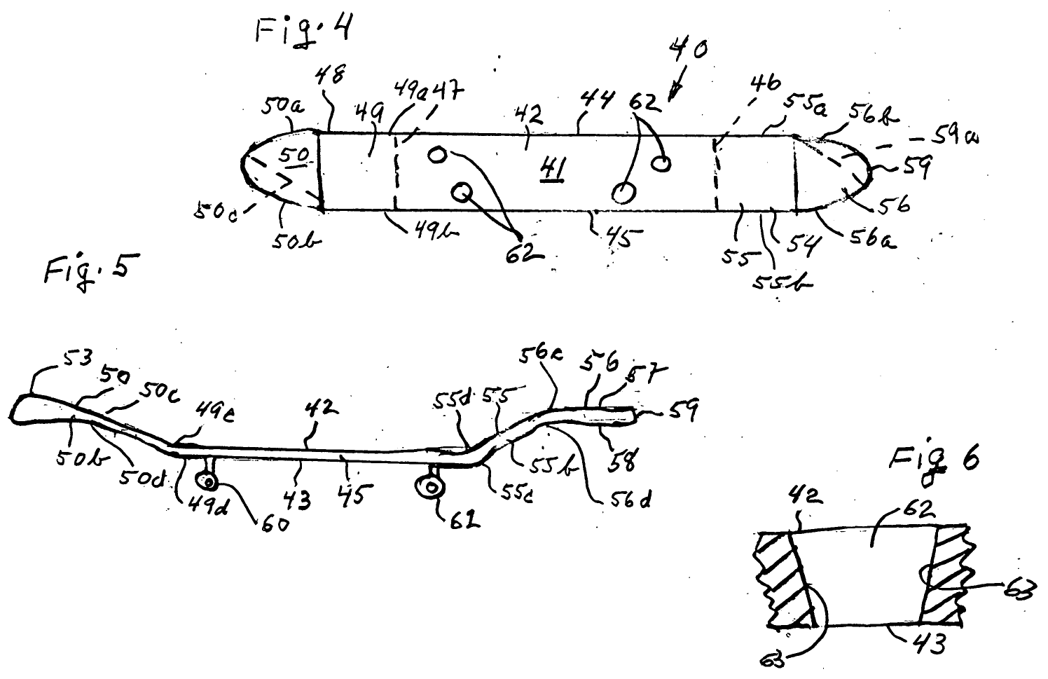

FIGS. 4 and 5 illustrate details of the winged skateboard of the invention. As shown therein, the winged skateboard of the invention, generally identified by reference numeral 40 has an elongated, generally rectangular skateboard platform 41 upon which a skateboarder stands to ride the skateboard. Platform 41 has a top horizontal planat surface 42 and a bottom horizontal planar surface 43 that is co-extensive with and parallel the top surface 42. Platform 41 has opposed side edges 44 and 45 a nominal rear end 46 and a nominal front end 47.

Extending forward and outward from the nominal front end 47 is an elongated forward projection member 48. This projection member 48 has an upwardly and outwardly disposed front angular section 49 having opposed side edges 49a and 49b from which there extends a horizontally disposed front projection section 50. Front projection section 50 has a lower horizontal planar surface 51 that is co-extensive with front projection section 50, opposed side edges 50a and 50b and a rounded front end 52. Front angular section 49 and front projection section 50 are contiguous to and integrally formed with platform 41.

As seen best in FIG. 5, the top and bottom surfaces of the angular transition from platform 41 to front angular section 49 and the angular transition from front angular section 49 to front projection section 50 both have smooth, arcuate surfaces as indicated at 49c and 49d and at 50c and 50d. When viewed together and taken as a whole, front projection section 50, arcuate surfaces 50c and 50d, front angular section 49, arcuate surfaces 49c and 49d and platform 41 form an S-shaped configuration. This S-shaped configuration permits smooth air flow over the skateboard surfaces and minimizes air turbulence.

Extending rearward from the nominal rear end 47 of the platform 41 is an elongated, rearwardly projecting member 54 having an upward, outwardly, angularly disposed rear section 55 with opposed side edges 55a and 55b. Extending outwardly from the upper end of rear angular section 55 is a horizontally disposed, rearwardly projecting section 56 having opposed side edges 56a and 56c, an upper horizontal planar surface 57, a lower horizontal planar surface 58 that is co-extensive with and parallel to the upper horizontal surface 57 and a rounded end. Rear angular section 55 and rearward projecting section 56 are contiguous to and integrally formed with platform 41.

As also best seen in FIG. 5, the top and bottom surfaces of the angular transition from platform 41 to rear angular section 55 and the angular transition from rear angular section 55 to rearwardly projecting section 56 both have smooth, arcuate surfaces as indicated at 55c and 55d and at 56c and 56d. When viewed together and taken as a whole, platform 41, arcuate surfaces 55c and 55d, rear angular section 55, angular surfaces 56c and 56d and rearwardly projecting section 56 form an S-shaped configuration that permits smooth air flow over the skateboard surfaces and minimizes air turbulence.

The geometric configuration formed by front angular section 49 and front projecting section 50 impart a wing-like characteristic to the skateboard. When the skateboard is being propelled forward, air passing beneath the bottom surface 43 of the platform 41 will be displaced at a faster rate than air passing over the upper surface 42 of the platform 41. The speed of this upper air is impeded and slowed down because it has a longer distance to travel over the projecting section 50 and the front angular section 49 before it reaches the top planar surface 42 of the platform 41. This difference in the rate of air speed creates a pressure differential between the slower, upper moving air and the faster, lower moving air creating an aerodynamic effect that gives the skateboard a “lifting” feature.

Essentially the same effect is created by the faster moving air passing beneath the bottom surface 43 and the impeded, slower moving air passing over the rear angular section 55 and rearward projecting section 56 to create a similar aerodynamic effect and give the skateboard even more “lift”

As shown in FIG. 5, the rounded front end 52 has an integrally formed, upward, arcuate segment 53 that extends rearwardly to meld with the upper surface 50c of the front projection section 50. The geometric configuration formed by the upward, arcuate segment 53 coupled with the lower planar surface 51 of the front projection section 59 is similar to the front or leading edge of an airplane wing and imparts the same aerodynamic effect to the winged skateboard of the invention as does the airplane wing to the airplane. This aerodynamic effect permits the skateboard of the invention to accelerate more quickly, attain faster forward speeds and provides an additional and enhanced “lift” to the front end of the skateboard.

The angle of the angularly disposed front section 49 and the angle of the angularly disposed rear section 56 each with respect to platform 41 can each be an oblique angle of from about 115 degrees to about 135 degrees.

In another embodiment shown in FIGS. 4 and 5, the side edge of elongated forward projection member 50 is diagonally canted from rounded front end 52 of forward projection member 50 rearwardly to its intersection with smooth, arcuate surfaces 50c and 50d as indicated by dash line 50e. Similarly, one side edge of rear projecting section 56 is diagonally canted from its rounded end 59 to its intersection with smooth, arcuate surfaces 56c and 56d as indicated by dashed line 59a.

These diagonally canted side edges 50a and 59a can be at an angle of from about 30 to about 60 degrees, preferably at 45 degrees, with respect to the longitudinal axis of the skateboard. These diagonally canted side edges 50a and 59a are preferably diagonally opposite each other along the length of the skateboard and impart additional aerodynamic properties to the skateboard as they resemble the swept back wings that are provided on many jet airplanes.

Attached to and suspended from bottom planar surface 43 by conventional means are two pairs of spaced apart wheels; a front pair 60 and a rear pair 61. Each pair of wheels 60 and 61 are conventionally interconnected with a common axis (not shown). The front pair of wheels are set inboard from the nominal front end 47 and the rear pair of wheels are set inboard from the nominal rear end 46. Each pair of wheels are preferably mounted so that the outer, planar surfaces of the wheels do not protrude or extend beyond the side edges 44 and 45 of the platform 41.

The platform 41 of the winged skateboard of the invention preferably has a plurality of apertures 62 formed therein that extend from the top planar surface 42 to and through the bottom planar surface 43. The geo,rtric configuration of these apertures is not critical and the can be round or circular, square, rectangular, trapezoidal, oval, oblong, star shaped, and the like. Preferably, these apertures are round or circular as shown in FIG. 4. These apertures remove sections from the platform 41 thereby reducing the overall weight of the skateboard.

As illustrated in FIG. 6, the wall 63 of a circular or round aperture 62 is flanged or tapered outwardly from the bottom opening in the bottom planar surface 43 and upwardly to the opening in the top planar surface 42. This geometric configuration is similar to an inverted, frusto-conical configuration With round or circular apertures 62, the diameter of the bottom opening can be from about 1½″ to about 2″ while the diameter the top opening can be from about 2″ to about 3″.

The length of the skateboard platform 41 can be about 24″ from nominal rear end 46 to nominal front end 47 and the width from side edge 44 to side edge 45 can be from about 8″ to about 9″ the overall length of the forward projecting member 48 from the nominal front end 47 to the rounded front end 52 can be from about 7″ to about 8″ with the length angular section 49 being from about 2″ to about 3″. The overall length of the rearward projecting member 54 from the nominal rear end 46 to the rounded rear end 59 can be from about 7″ to about 8″ with the length of the rear angular section 58 being from about 2″ to about 3″ Depending upon the materials used to manufacture the winged skateboard of the invention the thickness from rounded end 52 to rounded end 59 can be from about ¼″ to about ¾″. All side edges of the winged skateboard of the invention 40; i.e., side edges 44, 45, 49a, 40b, 50a, 50b, 55a, 55b, 56a and 56b are smooth and rounded to provide uninterrupted air flow and minimize turbulence.

The design of conventional, commercially available skateboards inherently limits the forward speeds that can be attained by the recreational skateboarder to about 5 mph to about 8 mph while the competitive skateboarder can reach forward speeds of about 15 mph. Due to the aerodynamic features of the winged skateboard of the invention, recreational skateboarders can attain forward speeds of 10 mph or more while the competitive skateboarder can reach speeds of 20 mpj or more.

The added rearwardly extending length of the winged skateboard of the invention enables the recreational skateboarder to more readily compensate for rough or uneven surfaces by being able to shift its weight backwards onto the rearwardly extending length to thereby ease the downward pressure of the front pairs of wheels and traverse the uneven or rough surface more readily while maintaining good balance.

As mentioned earlier, the aerodynamic effects created by the combination of the front angular section 49 and the front projecting section 50 as well as the combination of the rear angular section 55 and the rear projecting section 56 and by the added arcuate segment 53 of the winged skateboard of the invention causes air to flow along the lower planar surface 51 at a faster rate than the air passing over the top planar surface 42 as well as over arcuate segment 53. This creates an air pressure differential that results in giving the front end of the skateboard greater “lift”. This added “lift” is translated into faster forward speeds attainable by the recreational skateboarder as well as the competitive skateboarder. More importantly, this “lift” is significantly important to the competitive skateboarder as it can add a few more precious fractions of a second to the air-borne competitor enabling him or her to successfully execute more complex acrobatic maneuvers with greater ease and grace.

An additional aerodynamic effect is imparted to the winged skateboard of the invention by the flared walls of the apertures and the relative size of the bottom and top openings of the apertures. Unimpeded air will pass along the bottom planar surface 43 while air passing along the top planar surface 42 will be slowed by arcuate section 53. This alone creates a “lifting” effect along the top planar surface 42 that is enhanced by some of the faster moving air passing along the bottom planar surface 43 entering the bottom of an aperture 62 and being expelled from the top of the aperture at a slower rate. This creates a differential in air pressure that results in imparting even more “lift” to the skateboard.

The materials used to manufacture the winged skateboard of the invention are not critical provided the skateboard produced is durable, sturdy, rigid and strong enough to support varying human body weights. For example, pre-stressed hard woods can be used such as ash, cedar, oak, teak, and the like can be readily used in multiple or single plies. Similarly, metals such as lightweight aluminum and metal alloys are also suitable. In addition, plastics such as high density polyethylenes, polypropylenes, polysulfones, polyurethanes, and the like can be used.

The wheels used for commercially available skateboards are generally made from light weight metals such as aluminum and metal alloys. Such wheels are also suitable for use with the winged skateboard of the invention. However, since the surface over which competitive skateboards are run are completely different from those over which recreational skateboards are run, it is preferred that those winged skateboards of the invention that are intended for use in skateboard competitions be equipped with wheels that are made from polyurethane.

Although the winged skateboard of the invention has been described with particularity and in some detail, it will be appreciated to those skilled in the art that changes and modifications can be made therein without departing from the scope and spirit of the invention.

What is claimed:

1. A winged skateboard comprising:
(a) a skateboard platform having a nominal front end and a nominal rear end;
(b) an elongated forward projecting member;
(c) an elongated rearward projecting member; and.
(d) two pair of spaced apart wheels, a front pair and a rear pair, attached to and vertically suspended from said skateboard platform, each pair of said wheels being interconnected by means of a common axle.

2. The winged skateboard of claim 1 wherein said skateboard platform is an elongated, generally rectangular configuration having:
(a) a top horizontal planar surface;
(b) a bottom horizontal planar surface co-extensive with and parallel to said top surface; and,
(b) opposed side edges.

3. The winged skateboard of claim 1 wherein said forward projecting member is contiguous to and integrally formed with said skateboard platform.

4. The winged skateboard of claim 1 wherein said forward projecting member has a front angular section upwardly and outwardly disposed from said nominal front end and a horizontal planar front section outwardly disposed from the upper end of said front angular section.

5. The winged skateboard of claim 4 wherein said from angular section, said planar from section and said skateboard platform together form an S-shaped configuration.

6. The winged skateboard of claim 4 wherein the angle of said front angular section with respect to said skateboard platform is at an oblique angle of from about 115 degrees to about 135 degrees.

7. The winged skateboard of claim 4 wherein the front end of said horizontal front section has integrally formed therewith an upward, arcuate segment that tapers rearward to meld with said horizontal front section, the geometric configuration of said arcuate segment resembling the leading edge of an airplane wing.

8. The winged skateboard of claim 7 wherein one side edge of said planar front section is diagonally canted rearward from the front end of said arcuate segment at an angle of from about 30 degrees to about 60 degrees with respect to the longitudinal axis of said skateboard.

9. The winged skateboard of claim 1 wherein said rearward projecting member is contiguous to and integrally formed with said skateboard platform.

10. The winged skateboard of claim 1 wherein said rearward projecting member has an angular rear section extending upwardly and outwardly from said nominal rear end and a horizontal, planar rear section extending outwardly from the upper end of said angular rear section. .

11. The winged skateboard of claim 19 wherein said rearward projecting section, said planar rear section and said skateboard platform together form an S-shaped configuration.

12. The winged skateboard of claim 10 wherein the angle of said angular rear section with respect to said skateboard platform is at an oblique angle of from about 115 degrees to about 135 degrees.

13. The winged skateboard of claim 10 wherein one side edge of said planar rear section is diagonally canted rearward from its rear end at an angle of from about 30 degrees to about 60 degrees with respect to the longitudinal axis of said skateboard.

14. The winged skateboard of claim 1 wherein said skateboard platform has a plurality of spaced apertures formed therein extending from said top surface to and through said bottom surface.

15. The winged skateboard of claim 14 wherein the walls of said apertures are flared and tapered upwardly and outwardly from their openings in said bottom surface to their openings in said top surface.

16. A winged skateboard comprising:
(a) an elongated, generally rectangular skateboard platform having a nominal front end, a nominal rear end, a top horizontal planar surface, a bottom, horizontal planar surface co-extensive and parallel to said top surface and opposed side edges;
(b) an elongated forward projecting member contiguous to and integrally formed with said skateboard platform, said forward projecting member having a front angular section upwardly and outwardly disposed from said nominal front end a horizontal planar front section outwardly disposed from the upper end of said front angular section;
(c) an elongated rearward projecting member contiguous to and integrally formed with said skateboard platform, said rearward projecting member having a rear angular section upwardly and outwardly disposed from said nominal rear end and a horizontal planar rear section outwardly disposed from the upper end of said rear angular section; and
(d) Two pair of spaced apart wheels, a front pair and a rear pair, attached to and vertically suspended from said skateboard platform, each pair of said wheels being interconnected by means of a common axle.

17. The winged skateboard of claim 16 wherein said front angular section, said planar front section and said skateboard platform together form an S-shaped configuration.

18. The winged skateboard of claim 16 wherein said rearward projecting section, said planar rear section and said skateboard platform together form an S-shaped configuration.

19. The winged skateboard of claim 16 wherein the angle of said front angular section and the angle of said rear angular section each with respect to said skateboard platform are each oblique angles of from about 115 degrees to about 135 degrees.

20. The winged skateboard of claim 16 wherein the front end of said horizontal front section has integrally formed therewith an upward, arcuate section that tapers rearward to meld with said horizontal front section, the geometric configuration of said arcuate section and said taper resembling the leading edge of an airplane wing.

21. The winged skateboard of claim 16 wherein one side edge of said planar front section is diagonally canted rearward from the front end of said arcuate segment at an angle of from about 30 degrees to about 60 degrees with respect to the longitudinal axis of said skateboard.

22. The winged skateboard of claim 16 wherein one side edge of said planar rear section is diagonally canted rearward from its rear end at an angle of from about 30 degrees to about 60 degrees with respect to the longitudinal axis of said skateboard.

23. The winged skateboard of claim 16 wherein said skateboard platform has a plurality spaced apart apertures formed therein that extend from said top surface to and through said bottom surface, the walls of said apertures being flared and tapered upwardly and outwardly from their openings in said bottom surface to their openings in said top surface.
